(19) United States
(12) Patent Application Publication
(10) Pub. No.: US 2014/0187697 A1
(43) Pub. Date: Jul. 3, 2014

(54) ADHESIVES FOR BONDING POLYURETHANE AND VULCANIZED RUBBER

(71) Applicant: HYUNDAI MOTOR COMPANY, Seoul (KR)

(72) Inventors: Hyun-Chul Cho, Seoul (KR); Dai-Soo Lee, Seoul (KR); Dae-Woo Lee, Jeonju (KR)

(21) Appl. No.: 13/912,504

(22) Filed: Jun. 7, 2013

(30) Foreign Application Priority Data
Dec. 28, 2012 (KR) 10-2012-0155935

(51) Int. Cl. C09J 175/08

(52) U.S. Cl. CPC C09J 175/08
USPC 524/315; 525/460; 524/590

(57) ABSTRACT

Disclosed is an adhesive for bonding polyurethane and vulcanized rubber, and more specifically to an adhesive for bonding polyurethane and vulcanized rubber, which comprises: a first prepolymer, which is a reaction product of hydroxy-terminated polybutadiene polyol and isocyanate; a second prepolymer, which is a reaction product of polyether polyol, polyester polyol or a combination thereof, and isocyanate; and a radical initiator. The adhesive demonstrates excellent adhesive property even under harsh traveling conditions by using a chemical covalent-bond reaction of a body of a polyurethane tire and a vulcanized rubber tread material.

### CROSS-REFERENCE TO RELATED APPLICATION

This application claims priority under 35 U.S.C. §119 to Korean Patent Application No. 10-2012-0155935, filed on Dec. 28, 2012, in the Korean Intellectual Property Office, the disclosure of which is incorporated herein by reference in its entirety.

### BACKGROUND

(a) Technical Field

The present invention relates to an adhesive, and more specifically, to an adhesive for chemical bonding of a tread molded-product composed of vulcanized rubber and a body of a polyurethane tire.

(b) Background Art

Recently, developments of eco-friendly technologies have been made for reducing rolling resistance and weight with the purpose of improving vehicle fuel economy. Herein, the rolling resistance means resistance generated by vibration of wheels when the vehicle is running on the road, and it is caused by tire deformation, road profile, road impact, friction of bearing of each part and the like.

In the past, the preferred method for reducing the rolling resistance has been through the development and application if a tread, which is a face of the tire that makes contact with the road. However, the technologies related thereto are already saturated with little room for further improvement.

Accordingly, advanced companies worldwide are working on developing of a non-pneumatic tire using a polyurethane material for further reduction of the rolling resistance and weight.

However, friction resistance of the polyurethane material is lower than that of the conventional vulcanized rubber material. Thus, when the polyurethane material is applied to a tire body, the stop distance increases while braking as compared with the vulcanized rubber material-applied tire.

In order to solve the problem, there was an attempt to enhance physical properties of the polyurethane elastic body itself. However, it was determined that there is a limit to reducing the friction resistance because it is based on the polyurethane ingredient.

Accordingly, when the polyurethane material is applied to a tire, it is necessary to apply the vulcanized rubber to the tread. However, at this time, there is a problem in that a separate adhesive is needed to bond the tread molded-product consisting of the vulcanized rubber and the polyurethane material forming the tire body.

The description provided above as a related art of the present invention is just for helping understanding the background of the present invention and should not be construed as being included in the related art known by those skilled in the art.

### SUMMARY OF THE DISCLOSURE

The present invention provides an adhesive for bonding polyurethane and vulcanized rubber that shows excellent adhesive property even under harsh traveling conditions. In particular, the present invention provides an adhesive that uses chemical covalent-bond reaction of a body of a polyurethane tire and a vulcanized rubber tread material.

According to one aspect, the present invention provides an adhesive for bonding polyurethane and a vulcanized rubber composition comprising: a first prepolymer, which is a reaction product of hydroxy-terminated polybutadiene polyol and isocyanate; a second prepolymer, which is a reaction product of polyether polyol, polyester polyol or a combination thereof, and isocyanate; and a radical initiator.

According to various embodiments, it is preferred that the first prepolymer and the second prepolymer are reaction products produced by reacting a hydroxy group and an isocyanate group at a molar ratio of about 1:1.5˜2.5.

as According to an exemplary embodiment of the present invention, the isocyanate is methylene diphenyl diisocyanate (MDI), and the radical initiator is a peroxide or azo compound.

According to various embodiments, it is preferred that the adhesive composition is dissolved in a solvent to form a solution, wherein the amount of the adhesive composition is about 5 to 50% by weight based on the total weight of the solution. According to various embodiments, the solvent is toluene or methyl propionate.

According to various embodiments, it is preferred that the amount of the first prepolymer is about 50 to 70 parts by weight, the amount of the second prepolymer is about 30 to 50 parts by weight, and the amount of the radical initiator is about 0.1 to 5 parts by weight based on the total weight of the adhesive composition.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a conceptual diagram showing chemical structure applied between polyurethane prepolymer and vulcanized rubber before the adhesive composition according to the present invention is cured;

FIG. 2 is a conceptual diagram showing a chemical structure, where chemical bonds are formed, after the adhesive is cured according to an embodiment of the present invention; and

FIG. 3 is a picture of a fracture plane of a specimen bonded by the adhesive composition of Example 4 according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terms and the words used in the specification and claims should not be construed with common or dictionary meanings, but construed as meanings and conception coinciding the spirit of the invention based on a principle that the inventors can appropriately define the concept of the terms to explain the invention in the optimum method. Therefore, embodiments described in the specification and the configurations shown in the drawings are not more than the most preferred embodiments of the present invention and do not fully cover the spirit of the present invention. Accordingly, it should be understood that there may be various equivalents and modifications that can replace those when this application is filed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention now will be described in detail with reference to the accompanying drawings.

In one aspect, the present invention relates to an adhesive composition, which is used for bonding polyurethane and vulcanized rubber. The adhesive composition of the present invention provides excellent adhesive properties, particularly by chemical covalent-bonding therewith.

Specifically, the adhesive composition according to the present invention comprises: a first prepolymer, which is a reaction product of hydroxy-terminated polybutadiene polyol and isocyanate; a second prepolymer, which is a reaction product of polyether polyol, polyester polyol or a combination thereof, and isocyanate; and a radical initiator. According to preferred embodiments, in order to provide more improved adhesive strength for bonding of polyurethane and the vulcanized rubber, the amount of the first prepolymer is about 50 to 70 parts by weight, the amount of the second prepolymer is about 30 to 50 parts by weight, and the amount of the radical initiator is about 0.1 to 5 parts by weight, based on the total weight of the adhesive composition.

(A) Polyurethane Prepolymer

According to preferred embodiments, the polyurethane prepolymer of the present invention comprises: the first prepolymer, which is a reaction product of hydroxy-terminated polybutadiene polyol and isocyanate; and the second prepolymer, which is a reaction product of polyether polyol, polyester polyol or a combination thereof, and isocyanate. According to an exemplary embodiment, the representative chemical structure of the polyurethane prepolymer mixture is O═C═N˜˜NH—COO˜R₁˜OOC—NH˜˜N═C═O and O═C═N˜˜NH—COO˜R₂˜OOC—NH˜˜N═C═O.

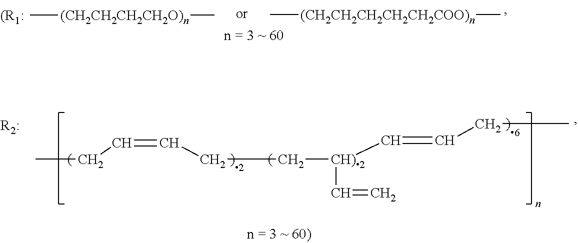

As described above, the polyurethane prepolymer is composed of the first prepolymer and the second prepolymer as a reaction product of the polyol ingredient and the isocyanate. In particular, of the hydroxy groups of the polyol ingredient are reacted with the isocyanate group at about 80° C. or less to form the reaction product.

Accordingly, the prepolymer contains unreacted isocyanate at a certain ratio, and it is preferred that the first prepolymer and the second prepolymer are reaction products produced by reacting a hydroxy group and an isocyanate group at the molar ratio of about 1:1.5˜2.5. According to preferred embodiment, the molecular weight of the polyol ingredients is about 400 to 4000 g/mol, and it may partially comprise diol, multi-valent glycol and the like.

According to embodiments of the present invention, it is preferred that the polyol ingredient comprises hydroxy-terminated polybutadiene polyol, and polyether polyol, polyester polyol or a combination thereof and the like. It is further preferred that a hydroxy-terminated polybutadiene polyol forms the first prepolymer by being reacted with the isocyanate. It is further preferred that a cross-linking reaction occurs through double bonding of the vulcanized rubber and free radicals.

According to preferred embodiments, the polyether polyol, the polyester polyol or the combination thereof is characterized by one or more of the following: it forms a second prepolymer by reacting with the isocyanate; it has affinity with a polyurethane elastic body or a polyurethane prepolymer forming the polyurethane elastic body; and it enables a covalent bond forming reaction, which forms a urethane group or allophanate group.

Specifically, it is preferred that the first prepolymer is capable of cross-linking with the vulcanized rubber with the help of the double bond of the vulcanized rubber and the radical initiator, and the possible reaction is shown in the following Reaction Formula 1.

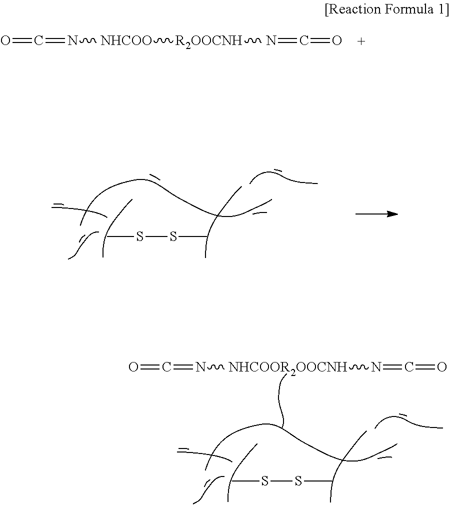

The R₂ is preferably a polybutadiene group.

In particular, when the R₂ molecular chain is contacted with or penetrates the vulcanized rubber, the covalent bond is formed with the help of the double bond of the vulcanized rubber and the radical initiator.

Further, the second prepolymer is preferable one that enables the covalent bond producing the allophanate, which forms the polyurethane elastic body or the polyurethane elastic body. A representative Reaction Formula is shown in the following Reaction Formula 2.

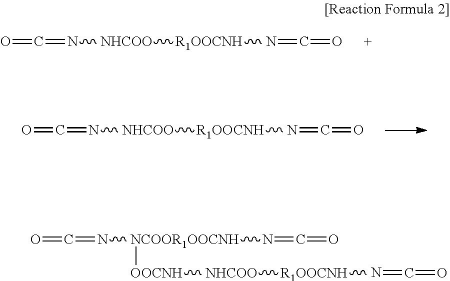

The R₁ is preferably a polyether group or a polyester group making the polyurethane elastic body.

Further, it is preferred that the isocyanate reacting with the polyol ingredient is a diisocyanate, such as methylene diphenyl diisocyanate (MDI), which is generally used for manufacturing the polyurethane elastic body.

(B) Radical Initiator

The radical initiator is a material used for free radical polymerization of vinyl monomers or cross-linking reaction of rubber, and any conventional radical initiators can suitably be used. According to preferred embodiments, the radical initiator is selected from peroxides and azo compounds, such as t-butyl perbenzoate (TBPB), whose degradation temperature forming radicals is similar with the curing temperature condition of the polyurethane prepolymer.

According to preferred embodiments, the adhesive composition according to the present invention is dissolved in a compound, as a solvent, so as to form a solution in order for the adhesive composition to penetrate to the vulcanized rubber after coating. In particular, the compound in which the adhesive composition is dissolved generates swelling due to its excellent affinity with the vulcanized rubber. The solvent may be, for example, toluene or methyl propionate and the like, and in consideration of swelling property, it is preferred that the adhesive composition is dissolved in the solvent in an amount of about 5 to 50% by weight based on the total weight of the solution.

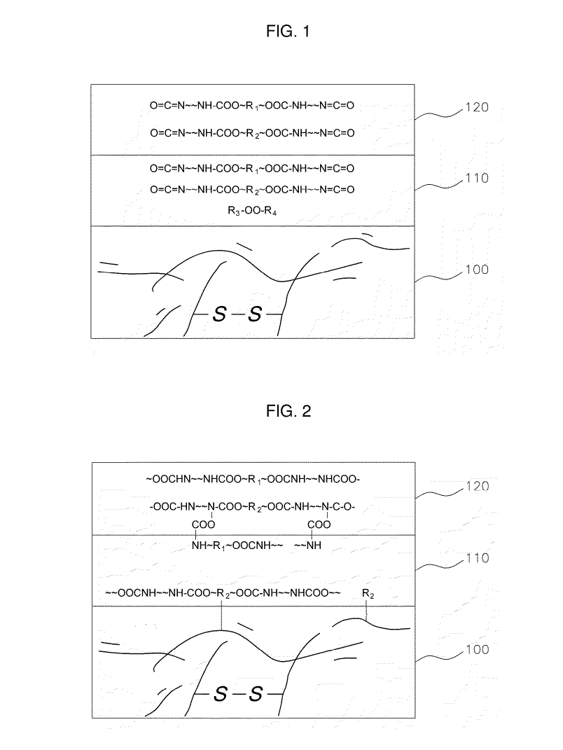

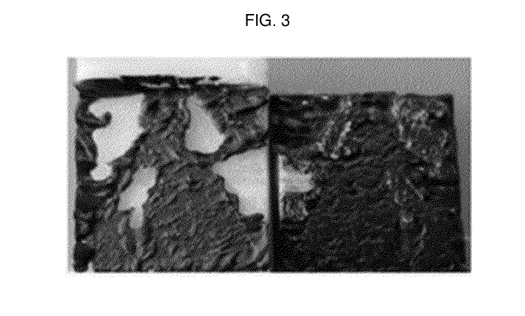

FIG. 1 is a conceptual diagram showing chemical structure applied between polyurethane prepolymer and vulcanized rubber before the adhesive composition according to the present invention is cured, and FIG. 2 is a conceptual diagram showing chemical structure, where chemical bonds are formed, after the adhesive is cured. As shown therein, the adhesive composition 110 according to the present invention is applied between the polyurethane 120 and the vulcanized rubber 100, and is cured under a common polyurethane curing condition (for example, keeping at about 120° C. for about 12 hours) to form a cross-link, thereby providing excellent adhesive strength,

### Example 1

Hereinafter, the present invention will be described in further detail with reference to Preparation Example and Example. It will be obvious to a person having ordinary skill in the art that these examples are illustrative purposes only and are not to be construed to limit the scope of the present invention.

[Preparation of Polyurethane Prepolymer]

Polytetramethylene ether glycol (PTMEG-2000) having molecular weight of 2000 and functional group number per molecule of 2, which is used for manufacturing a polyurethane prepolymer as an adhesive composition, and hydroxy-terminated polybutadiene (HTPB) having molecular weight of 2800 and functional group number per molecule of 2.3 are compounds having a hydroxy group in common and tend to absorb moisture.

However, because the moisture also reacts with the isocyanate, which is reacted when manufacturing the prepolymer, the said compounds were first dried. In particular, the compounds were stored in a vacuum oven kept at 60° C. for 24 hours before use. At this time, because it is advantageous to use the same isocyanate with the isocyanate used for manufacturing the polyurethane elastic body in order to secure excellent affinity on the interface, 4,4-methylene diphenyl diisocyanate (MDI) was used.

The polyurethane prepolymer was manufactured by gradually adding the dried polyol to the MDI while maintaining a melting temperature at 60° C., and as the addition ratio of the reactants, representatively, the molar ratio of the hydroxy group and the isocyanate was 1:2. The reaction was conducted under nitrogen atmosphere to block the moisture; the addition was slowly conducted so that temperature of the reaction system did not exceed 80° C. because there was temperature rise due to heat generation. At this time, as a free radical initiator for cross-linking with the vulcanized rubber, t-butyl perbenzoate (TBPB), which is degraded under curing condition of the polyurethane prepolymer, was used.

The first prepolymer manufactured with the MDI and the hydroxy-terminated polybutadiene, the second prepolymer manufactured with the MDI and the Polytetramethylene ether glycol (PTMEG-2000), and the t-butyl perbenzoate as the radical initiator were mixed according to the parts by weight as listed in the following Table 1 to manufacture the adhesive composition. The adhesive composition was then dissolved in methylpropionate as a solvent in an amount of 20% by weight based on the total weight.

TABLE 1

| Section | Exam. 1 | Exam. 2 | Exam. 3 | Exam. 4 | Exam. 5 | Exam. 6 |
|---|---|---|---|---|---|---|
| First | 100 | 100 | 60 | 60 | 40 | 0 |
| Prepolymer | | | | | | |
| Second | — | — | 40 | 40 | 60 | 100 |
| Prepolymer | | | | | | |
| Radical | 1 | 2 | 1 | 2 | 2 | 2 |
| Initiator | | | | | | |

[Adhesive Strength Test]

In order to test the adhesive strength, the adhesive compositions having the compositions of the above Examples 1 to 6 were vulcanized by using 1,4-butane diol, and as vulcanized rubber, the carbon black-added vulcanized rubber, which is conventionally used to fabricate a tire rubber tread, was used.

The prepared adhesive solution was coated on the surface of the vulcanized rubber, and then after the solvent was dried out, the polyurethane prepolymer forming the polyurethane elastic body was casted together with a curing agent followed by curing at 120° C. for 24 hours. Then, the adhesive strength was tested by 90 degree T-peel test.

TABLE 2

| | Exam. 1 | Exam. 2 | Exam. 3 | Exam. 4 | Exam. 5 | Exam. 6 |
|---|---|---|---|---|---|---|
| Adhesive | 5,250 | 5,375 | 8,915 | 11,350 | 5,390 | 5,194 |
| Strength | | | | | | |
| (N/m) | | | | | | |
| Note | Interfacial | Interfacial | Cohesive | Cohesive | Interfacial | Interfacial |
| | Failure | Failure | Failure | Failure | Failure | Failure |

The above Table 2 is a table showing the results of the adhesive strength test, and as shown in the Table, the intensity adhesive strength was higher on average compared with the intensity of the adhesive strength of the conventional rubber-type adhesive or thermosetting resin adhesive. This is, because the adhesive strength of the present compositions was embodied by the chemical bonding caused by the cross-linking, and particularly, Examples 3 and 4 showed cohesive failure, which is rupture generated inside the adhesive.

FIG. 3 is a picture of a fracture plane of a specimen bonded by the adhesive composition of Example 4, and as shown in the picture, the upper white part is the fracture plane of the polyurethane and the black part is the cross section of the vulcanized rubber. The picture shows cohesive failure, which means rupture generated inside the adhesive. Such cohesive failure demonstrates excellent adhesive strength because the adhesive strength was embodied by the chemical bonding caused by the cross-linking. This is in contrast with the conventional adhesive.

The adhesive according to the present invention having the constitution described above has an advantage in that more excellent adhesive property can be expressed by embodying adhesive strength by chemical bonding formed by cross-linking. This is in contrast with the conventional rubber-type adhesive or thermosetting resin adhesive which embodies adhesive strength by physical bonding.

Further, when used in a polyurethane tire, the present adhesive enables excellent bonding of the polyurethane body and the vulcanized rubber tread material, and therefore, it has the effects of maintaining the adhesive strength even under harsh traveling conditions and reducing stop distance while braking by use of the vulcanized rubber material.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. An adhesive composition for bonding polyurethane and vulcanized rubber composition comprising:
a first prepolymer, which is a reaction product of hydroxy-terminated polybutadiene polyol and isocyanate;
a second prepolymer, which is a reaction product of polyether polyol, polyester polyol or a combination thereof, and isocyanate; and
a radical initiator.

2. The adhesive composition according to claim 1, wherein the first prepolymer and the second prepolymer are reaction products produced by reacting a hydroxy group and a isocyanate group at a molar ratio of about 1:1.5˜2.5.

3. The adhesive composition according to claim 1, wherein the isocyanate is methylene diphenyl diisocyanate (MDI).

4. The adhesive composition according to claim 1, wherein the radical initiator is a peroxide or azo compound.

5. The adhesive composition according to claim 1, which is dissolved in a solvent to form a solution, wherein the amount of the adhesive composition is about 5 to 50% by weight based on the total weight of the solution.

6. The adhesive composition according to claim 5, wherein the solvent is toluene or methyl propionate.

7. The adhesive composition according to claim 1, wherein the amount of the first prepolymer is about 50 to 70 parts by weight, the amount of the second prepolymer is about 30 to 50 parts by weight, and the amount of the radical initiator is about 0.1 to 5 parts by weight based on the total weight of the adhesive composition.
